(19) United States
(12) Patent Application Publication
(10) Pub. No.: US 2007/0181479 A1
(43) Pub. Date: Aug. 9, 2007

(54) Column and method of manufacturing the column

(75) Inventors: Akira Yamamoto, Tokyo (JP); Yusuke Iimori, Tokyo (JP); Masaki Tanaka, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/602,232

(22) Filed: Nov. 21, 2006

(30) Foreign Application Priority Data
Nov. 21, 2005 (JP) 2005-335938
Nov. 21, 2005 (JP) 2005-335939

(51) Int. Cl. B01D 15/08

(52) U.S. Cl. 210/198.2; 73/61.53

(57) ABSTRACT

A column for adsorbing a component in a sample has a tubular member through which a sample flows. The column also has a stationary phase housed in the tubular member and formed by an aggregate of a plurality of particles. At least a portion of surfaces of the particles is made of the same material as at least a portion of an inner wall surface of the tubular member so that a component in the sample is adsorbed on both of the surfaces of the particles and the inner wall surface of the tubular member.

### BACKGROUND OF THE INVENTION

1. Field of the Invention

The present invention relates to a column and a method of manufacturing a column.

2. Description of the Prior Art

For example, a chromatography column including a cylindrical tubular member (capillary) and a stationary phase housed in the tubular member is used in liquid chromatography. A sample liquid is passed through the tubular member. Components in the sample are separated from each other by using a difference of moving speeds of the components, which is based on adsorption characteristics of the components and a difference of distribution coefficients at a portion of the stationary phase with which the sample is brought into contact.

Meanwhile, chromatography columns include a particle packed column having a stationary phase formed by carrier particles filled therein. Generally, a particle packed column has a filter mounted at a lower end of the column. Particulate carriers (carrier particles) are packed above the filter to form a packed bed (stationary phase). Another filter is mounted above the packed bed. The lower filter serves to prevent the packed bed from falling off from the lower end of the column. The upper filter serves to maintain the flatness of an upper end surface of the packed bed.

Such a column generally has excellent separation characteristics when it has a large size. However, a column having a small size, particularly a small diameter, has the following problems.

Specifically, a column having a small diameter is often used to analyze a small amount of sample with high accuracy and high sensitivity. However, with the aforementioned column having filters, a portion of components separated by the packed bed may be mixed again by a turbulent flow produced near the lower filter. If such mixture is caused in the case of a small amount of sample, then a ratio of mixed components to separated components is increased, making it difficult to analyze the sample with high accuracy and high sensitivity.

Further, in a packed bed formed by carrier particles, molecular diffusion and turbulence are caused by gaps between the carrier particles. As a result, a separation capability of the column is degraded. The gaps between the carrier particles become smaller as the carrier particles have a smaller particle diameter. Accordingly, it is desirable that carrier particles having a small particle diameter are used for a column having a small diameter, which is used to analyze a sample with high accuracy and high sensitivity. However, if carrier particles having a small particle diameter are used in a column having a filter, then the filter is clogged by the carrier particles to thereby degrade the column.

In order to resolve the above problems, there has recently been proposed a monolith column having a skeletal structure in the form of a three-dimensional network with vacant spaces integrally formed therein. For example, JP-A-2002-296258 discloses such a monolith column.

A monolith column disclosed by JP-A-2002-296258 has a skeletal structure made of porous glass or porous ceramic. Further, porous glass or porous polymer having micropores is filled into pores in the skeletal structure. The monolith column is composed by housing the skeletal structure in a tubular member made of resin and, for example, connected to a pump for supplying a liquid.

Since such a monolith column has a skeletal structure with porous portions integrally formed therein, the monolith column can be fixed in a tubular member without a filter by sealing or fitting. Thus, the monolith column can avoid the aforementioned problems caused by use of a filter, such as mixture of components due to a turbulent flow produced near a filter, clogging of a filter, and pressure increase of a column.

However, when a diameter of a monolith column is reduced, a surface area of an inner wall surface of a tubular member is increased with respect to a surface area of porous portions, so that adsorption of components on the inner wall surface of the tubular member cannot be disregarded. Specifically, the porous portions and the tubular member of the monolith column are formed by different materials, which have different adsorption characteristics. Accordingly, when the surface area of the inner wall surface of the tubular member is increased with respect to the surface area of the porous portions, the adsorption characteristics of the inner wall surface of the tubular member has a greater influence on the separation performance. Thus, an expected separation performance cannot be obtained in the porous portions.

Further, the monolith column has gaps between an inner wall surface of the tubular member and a stationary phase. The flow velocity of a liquid flowing through these gaps is higher than that of a liquid flowing through the porous stationary phase. Accordingly, the liquid flowing through the tubular member has a variation in flow velocity. Thus, the capability of reliably separating components in a sample (separation performance) cannot satisfactorily be obtained.

### SUMMARY OF THE INVENTION

The present invention has been made in view of the above drawbacks. It is, therefore, a first object of the present invention to provide a column which has a good separation performance and can perform an analysis with high accuracy and high sensitivity even if a diameter of the column is reduced.

A second object of the present invention is to provide a method of manufacturing such a column.

According to a first aspect of the present invention, there is provided a column which has a good separation performance and can perform an analysis with high accuracy and high sensitivity even if a diameter of the column is reduced. The column adsorbs a component in a sample. The column has a tubular member through which a sample flows. The column also has a stationary phase housed in the tubular member and formed by an aggregate of a plurality of particles. At least a portion of surfaces of the particles is made of the same material as at least a portion of an inner wall surface of the tubular member so that a component in the sample is adsorbed on both of the surfaces of the particles and the inner wall surface of the tubular member.

With the above arrangement, for example, even if a diameter of the column is reduced, it is possible to have a good separation performance and perform an analysis with high accuracy and high sensitivity.

It is desirable that a portion of the stationary phase is fixed to the inner wall surface of the tubular member. In this case, since gaps become unlikely to be formed between the stationary phase and the inner wall surface of the tubular member, it is possible to reduce a variation of a flow velocity of a liquid flowing through the column.

It is desirable that the plurality of particles are fixed to each other so as to integrally form the aggregate. In this case, the stationary phase can have a large surface area. Specifically, the stationary phase can have a large contact area with which the component in the sample is brought into contact. Therefore, the stationary phase can adsorb the component in the sample efficiently.

It is desirable that the plurality of particles have an average particle diameter of about 0.1 to 50 μm. In this case, it is possible to maintain a sufficient surface area of the stationary phase. Accordingly, it is possible to enhance a ratio at which the component in the sample is held in the stationary phase.

It is desirable that the stationary phase has a specific surface area of about 10 to 1000 m²/g. In this case, the stationary phase can maintain a sufficient efficiency of holding the component of the sample and have such a mechanical strength so as not to be broken when a liquid passes through the stationary phase.

It is desirable that the tubular member includes an inner hollow portion having a cross-sectional area of about 0.001 to 1.0 mm² in a direction perpendicular to a direction in which the sample flows through the tubular member. With the column having such a narrow tubular member, even a small amount of liquid sample can be analyzed with high accuracy and high sensitivity.

It is desirable that an entirety of the tubular member is made of the same material as the portion of surfaces of the particles. In this case, the entire tubular member has a uniform coefficient of thermal expansion. Accordingly, even if the temperature of the column is drastically changed, thermal stress intensively applied to fixed portions can readily be relaxed so as to reliably prevent breakage of the column.

It is desirable that an entirety of the portion of surfaces of the particles is made of the same material as the portion of an inner wall surface of the tubular member. In this case, the entire stationary phase has a uniform coefficient of thermal expansion. Accordingly, even if the temperature of the column is drastically changed, thermal stress intensively applied to fixed portions can readily be relaxed so as to reliably prevent breakage of the column.

It is desirable that the aforementioned same material comprises a ceramic material. In this case, a trace of protein components or the like can repeatedly be analyzed with high accuracy and high speed. Further, it is possible to relatively readily fix the particles to each other and fix the stationary phase to the inner wall surface of the tubular member.

It is desirable that the ceramic material includes a calcium phosphate-based compound as a primary component. In this case, the stationary phase can be used to separate various kinds of proteins having a variety of isoelectric points.

It is desirable that the calcium phosphate-based compound includes hydroxyapatite or tricalcium phosphate as a primary component. In this case, the stationary phase can very efficiently adsorb tissue-derived polymer such as protein and DNA.

According to the first aspect of the present invention, the column has a tubular member and a stationary phase housed in the tubular member and formed by an aggregate of a plurality of particles. At least a portion of surfaces of the particles is made of the same material as at least a portion of an inner wall surface of the tubular member. Both of the inner wall surface of the tubular member and the surfaces of the particles can have the same function of adsorbing the component in the sample. Accordingly, for example, even if a ratio of an area of the inner wall surface of the tubular member to a surface area of the stationary phase is increased with the tubular member having a reduced diameter such that an influence from the inner wall surface of the tubular member on the component in the sample cannot be disregarded, the sample can be analyzed with high accuracy and high sensitivity.

Further, in a case where the stationary phase is formed by a plurality of particles integrally fixed to each other, it is possible to prevent the stationary phase from falling off from the tubular member without any filter. At the same time, the stationary phase can have a large surface area, i.e., a large contact area with which the component in the sample is brought into contact. Therefore, the stationary phase can adsorb the component in the sample efficiently.

According to a second aspect of the present invention, there is provided a method of manufacturing a column which has a good separation performance and can perform an analysis with high accuracy and high sensitivity even if a diameter of the column is reduced. According to this method, a plurality of particles for a stationary phase are filled into a tubular member. A heat treatment is performed on the tubular member filled with the plurality of particles to fix the plurality of particles to each other for forming the stationary phase and to fix a portion of the stationary phase to an inner wall surface of the tubular member.

With the above method, it is possible to produce a column which can have a good separation performance and perform an analysis with high accuracy and high sensitivity even if a diameter of the column is reduced.

It is desirable that the tubular member and the plurality of particles used in the filling process include a compact of a ceramic material or a temporary sintered member in which temporary burning is conducted on a compact of a ceramic material. In this case, it is possible to relatively easily fix the particles firmly to each other and fix the stationary phase firmly to the inner wall surface of the tubular member.

It is desirable that the temporary sintered member forming the tubular member and the temporary sintered member forming the plurality of particles have substantially the same degree of sintering. In this case, the particles and the tubular member are shrunk substantially at the same shrinkage percentage during the heat treatment. As a result, gaps are unlikely to be formed between the stationary phase and the inner wall surface of the tubular member. Thus, it is possible to obtain a column in which the stationary phase is reliably fixed to the inner wall surface of the tubular member.

It is desirable that the tubular member and the plurality of particles are made of the same ceramic material. In this case, the inner wall surface of the tubular member can have adsorption characteristics and distribution characteristics equivalent to those of the stationary phase with respect to the component in the sample.

It is desirable that the same ceramic material includes a calcium phosphate-based compound as a primary component. In this case, the stationary phase can be used to separate various kinds of proteins having a variety of isoelectric points.

It is desirable that the calcium phosphate-based compound includes hydroxyapatite or tricalcium phosphate as a primary component. In this case, the stationary phase can very efficiently adsorb tissue-derived polymer such as protein and DNA.

The filling process may include supplying a particle containing liquid containing the plurality of particles and a liquid component into the tubular member, moving the plurality of particles toward an end of the tubular member, and removing the liquid component from the particle containing liquid. In this case, the particles can efficiently be packed into the tubular member with ease.

It is desirable that the moving process includes applying a centrifugal force toward the end of the tubular member to the plurality of particles. In this case, the particles can be filled into the tubular member at a high density. Further, it is possible to readily fill the particles into a number of tubular members by only one operation.

Alternatively, the filling process may include supplying the plurality of particles into the tubular member and consolidating the plurality of particles. In this case, the particles can readily be packed into the tubular member without use of a device.

It is desirable that the consolidating process includes applying vibration to the tubular member supplied with the plurality of particles. In this case, it is possible to reliably prevent deformation of the particles and the tubular member and efficiently fill the particles into the tubular member.

It is desirable that the heat treatment is performed at a heat treatment temperature of about 1200 to 1450° C. In this case, the particles and the tubular member can reliably be sintered by the heat treatment while the ceramic material is prevented from being decomposed. Further, it is possible to reliably fix the particles to each other and reliably fix the stationary phase to the inner wall surface of the tubular member.

It is desirable that the heat treatment is performed for about 0.5 to 10 hours. In this case, shape deformation of the particles and the tubular member during the sintering can be optimized. The bonding can reliably be conducted while the shapes of the particles and the tubular member are maintained.

It is desirable that temperature is gradually (in a stepwise manner) increased to the heat treatment temperature. In this case, it is possible to fix the particles to each other and fix the stationary phase to the inner wall surface of the tubular member while the shapes of the particles and the tubular member are maintained.

It is desirable that the tubular member includes an inner hollow portion having a cross-sectional area of about 0.001 to 1.0 mm². With the column having such a narrow tubular member, even a small amount of liquid sample can be analyzed with high accuracy and high sensitivity.

According to the second aspect of the present invention, a heat treatment is performed on the tubular member filled with the plurality of particles to fix the plurality of particles to each other for forming the stationary phase and to fix a portion of the stationary phase to an inner wall surface of the tubular member. Accordingly, gaps become unlikely to be formed between the stationary phase and the inner wall surface of the tubular member. As a result, it is possible to reduce a variation of a flow velocity of a liquid flowing through the column. Thus, it is possible to produce a column which can have a good separation performance and perform an analysis with high accuracy and high sensitivity even if a diameter of the column is reduced.

Further, in a case where the tubular member and the plurality of particles to be subjected to the heat treatment include a compact of a ceramic material or a temporary sintered member in which temporary burning is conducted on a compact of a ceramic material, it is possible to fix the particles firmly to each other and fix the stationary phase firmly to the inner wall surface of the tubular member.

Furthermore, in a case where the tubular member and the plurality of particles to be subjected to the heat treatment include a temporary sintered member in which temporary burning is conducted on a compact of a ceramic material, it is possible to produce a column in which the stationary phase is fixed to the inner wall surface of the tubular member more reliably if the stationary phase and the tubular member have substantially the same degree of sintering.

The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

FIG. 1 is a schematic view showing a column according an embodiment of the present invention;

FIGS. 2A and 2B are schematic views explanatory of a method of manufacturing the column shown in FIG. 1;

FIG. 3 is a schematic view explanatory of a method of manufacturing the column shown in FIG. 1;

FIG. 4 is a photomicrograph of a column produced in Example I;

FIG. 5 is a photomicrograph of the column produced in Example I;

FIG. 6A is a graph showing a result of an analysis of components eluted from the column produced in Example I; and

FIG. 6B is a graph showing a result of an analysis of components eluted from a column produced in Reference Example VI.

### DETAILED DESCRIPTION OF THE INVENTION

A column and a method of manufacturing the column according to preferred embodiments of the present invention will be described below with reference to the accompanying drawings.

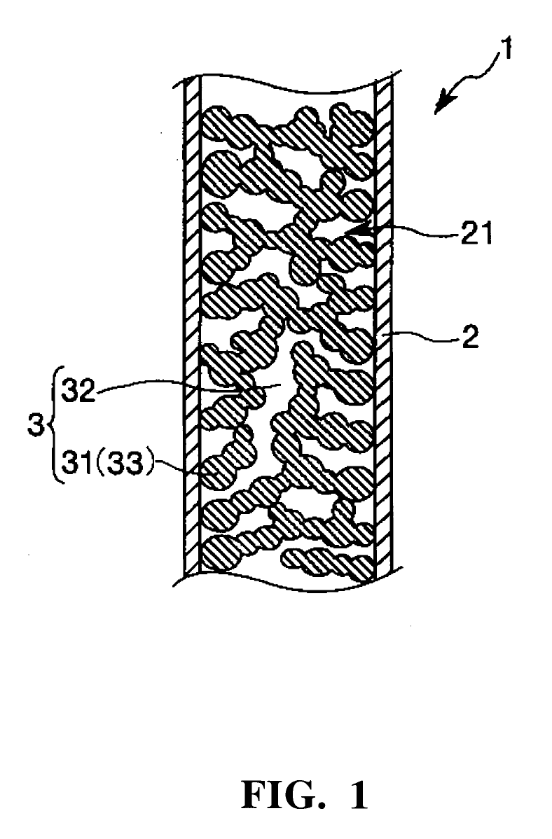

FIG. 1 is a schematic view showing a column according an embodiment of the present invention. In the following description, upper and lower sides in FIG. 1 will be referred to as “upper” and “lower,” respectively. For example, a column according to the present invention can be used as a column for liquid chromatography or gas chromatography. In the following description, a column according to the present invention will be described with a representative case in which the column is used for liquid chromatography.

As shown in FIG. 1, a column 1 has a tubular member 2 and a stationary phase 3 housed in the tubular member 2. When a liquid sample is passed through the tubular member 2, components in the sample are separated from each other by using a difference of moving speeds of the components, which is based on adsorption characteristics and a difference of distribution coefficients.

The tubular member 2 shown in FIG. 1 has a cylindrical shape including a hollow portion (inner hollow portion) 21. Since the tubular member 2 has a cylindrical shape, a gap is unlikely to be formed between an inner wall surface of the tubular member 2 and the stationary phase 3. Further, the tubular member 2 has an injection port provided on one end of the tubular member 2 for injecting a liquid sample into the tubular member 2. The tubular member 2 has a discharge port provided on the other end of the tubular member 2 for discharging components separated from the sample. It is to be noted that the tubular member 2 may have any tubular shapes with various cross-sectional shapes instead of the cylindrical shape.

A transverse cross-sectional area of the hollow portion (inner hollow portion) 21 in the tubular member 2, i.e., a cross-sectional area in a direction perpendicular to a direction through which a liquid sample passes in the tubular member 2, is preferably in a range of about 0.001 to 1.0 mm², more preferably in a range of about 0.01 to 0.2 mm², and still more preferably in a range of about 0.01 to 0.1 mm². With the column 1 having such a narrow tubular member 2, even a small amount of liquid sample can be analyzed with high accuracy and high sensitivity.

The stationary phase 3 is housed within the hollow portion 21 of the tubular member 2. When a liquid sample is brought into contact with the stationary phase 3, at least a portion of components contained in the liquid sample is held (or captured) by the stationary phase 3. At the same time, when an effluent liquid is brought into contact with the stationary phase 3, some of the held components are detached from the stationary phase 3 depending upon differences of their holding force.

A mechanism for holding components in the stationary phase 3 is not limited to a specific mechanism. For example, electrostatic coupling, capture into holes formed in the stationary phase 3, coupling of a protein and a ligand (e.g., an antigen and an antibody), and affinity to a specific functional group may be employed to hold components on the stationary phase 3.

The stationary phase 3 shown in FIG. 1 has a skeletal structure 31 with gaps 32 formed therein. The skeletal structure 31 is formed by a plurality of particles 33 fixed in the form of a three-dimensional network. The gaps 32 serve as passages for a liquid (a liquid sample and an effluent liquid). A portion of the skeletal structure 31 (the stationary phase 3) is fixed to contact portions on the inner wall surface of the tubular member 2.

In the present embodiment, the entire tubular member 2 and the particles 33 are made of the same kind of material. Specifically, both of the inner wall surface of the tubular member 2 and surfaces of the particles 33 have the same function of adsorbing components in the sample. Thus, the tubular member 2 can also have adsorption characteristics and distribution characteristics equivalent to those of the stationary phase 3 with respect to components in the sample.

Accordingly, for example, even if a ratio of an area of the inner wall surface of the tubular member 2 to a surface area of the stationary phase 3 is increased with the tubular member 2 (the column 1) having a reduced diameter such that an influence from the inner wall surface of the tubular member 2 on components in the sample cannot be disregarded, the sample can be analyzed with high accuracy and high sensitivity.

Further, the inner wall surface of the tubular member 2 can be utilized to separate components in the sample. Accordingly, it is possible to maintain a high separation performance of the stationary phase 3 of the column 1 even if the diameter of the tubular member 2 is reduced.

Furthermore, since the entire tubular member 2 and the particles 33 are made of the same kind of material, the entire tubular member 2 and the entire stationary phase 3 have a uniform coefficient of thermal expansion. Hence, the entire column 1 has a uniform coefficient of thermal expansion. Accordingly, even if the temperature of the column 1 is drastically changed, thermal stress intensively applied to fixed portions can readily be relaxed so as to reliably prevent breakage of the column 1 (the tubular member 2 and the stationary phase 3).

The surfaces of the tubular member 2 and the particles 33 are formed of a compact substance. Portions other than the surfaces (the interiors of the tubular member 2 and the particles 33) are formed of a compact substance, a porous material, or a gel material. Examples of the compact substance include ceramic materials and naturally-occurring polymers. Further, examples of the porous material include porous silica and porous polymers in which pores are formed in the aforementioned compact substance. Furthermore, examples of the gel material include silica gel, chemically modified silica gel, and synthetic polymer gel.

It is desirable that the tubular member 2 and the particles 33 are mainly made of ceramic material. Ceramic material is chemically stable and has a thermal resistance. Accordingly, when such ceramic material is used for the tubular member 2 and the stationary phase 3 (the particles 33), for example, protein and lipid irreversibly adsorbed on the stationary phase 3 can be dissolved in a strong alkali, cleaned, and removed. Alternatively, organic compounds can be evaporated and removed by heating and combusting. As a result, a trace of protein components or the like can repeatedly be analyzed with high accuracy and high speed.

Further, because of a thermal resistance of ceramic material, a hydrogen flame ionization detector can be provided near the discharge port of the tubular member 2 for detecting organic compounds discharged from the discharge port. The hydrogen flame ionization detector combusts and ionizes organic compounds by a hydrogen flame to detect the organic compounds.

Furthermore, ceramic material has the following advantages. When the same kinds of ceramic materials are brought into contact with each other at a high temperature, it is possible to relatively easily achieve strong bonding caused by interdiffusion. Thus, it is possible to relatively easily fix the particles 33 firmly to each other and fix the stationary phase 3 firmly to the inner wall surface of the tubular member 2. Specifically, when the tubular member 2 and the particles 33 are made of ceramic material, interdiffusion is readily caused by contact of the ceramic materials at a high temperature. Accordingly, it is possible to relatively easily fix the particles 33 firmly to each other and fix the particles 33 (the stationary phase 3) firmly to the inner wall surface of the tubular member 2.

Examples of the ceramic material include calcium phosphate-based compounds, aluminum oxide compounds, zirconium oxide compounds, silicon oxide compounds, and titanium oxide compounds. When components to be separated include protein, it is desirable that the ceramic material is primarily made of a calcium phosphate-based compound. Calcium phosphate-based compounds have a high affinity and exhibit both cation exchange properties and anion exchange properties. Accordingly, for example, calcium phosphate-based compounds interact with both a carboxyl group and an amino group of protein. Thus, calcium phosphate-based compounds can be used to separate various kinds of proteins having a variety of isoelectric points. Calcium phosphate-based compounds are suitable not only for separation of protein, but also for separation of tissue-derived components such as nucleic acids.

Calcium phosphate-based compounds are not limited to a specific compound. Various compounds having a Ca/P ratio of 1 to 2 can be used as the ceramic material. Examples of the calcium phosphate-based compounds include hydroxyapatite (Ca₁₀(PO₄)₆(OH)₂), fluorapatite (Ca₁₀(PO₄)₆F₂), chlorapatite (Ca₁₀(PO₄)₆Cl₂), tricalcium phosphate (Ca₃(PO₄)₂), calcium pyrophosphate (Ca₂P₂O₇), and calcium monohydrogen phosphate (CaHPO₄). Two or more compounds of the above examples may be mixed with each other.

It is desirable that hydroxyapatite or tricalcium phosphate is used as a primary component of the calcium phosphate-based compound. Such a calcium phosphate-based compound is used as biomaterial. Thus, such a calcium phosphate-based compound can adsorb tissue-derived components such as protein and DNA very efficiently.

For example, the above calcium phosphate-based compounds can be synthesized by a wet synthesis method, a dry synthesis method, a hydrothermal synthesis method, and the like. In this case, the calcium phosphate-based compounds may include a substance (raw material) remaining after the synthesis or a second order reaction product (by-product) produced during the synthesis.

Further, the tubular member 2 and the stationary phase 3 may be made of different kinds of ceramic materials. However, it is desirable that the tubular member 2 and the stationary phase 3 are made of the same kind of ceramic material. In this case, the inner wall surface of the tubular member 2 can also have adsorption characteristics and distribution characteristics equivalent to those of the stationary phase 3 with respect to components in the sample.

Accordingly, for example, even if a ratio of an area of the inner wall surface of the tubular member 2 to a surface area of the stationary phase 3 is increased with the tubular member 2 (the column 1) having a reduced diameter such that an influence from the inner wall surface of the tubular member 2 on components in the sample cannot be disregarded, the sample can be analyzed with high accuracy and high sensitivity.

Further, when the diameter of the tubular member 2 is reduced, the inner wall surface of the tubular member 2 can be utilized to separate components in the sample. Accordingly, it is possible to maintain high separation performance of the stationary phase 3 of the column 1.

As described above, the stationary phase 3 shown in FIG. 1 is formed by the skeletal structure 31, and a portion of the skeletal structure 31 (stationary phase 3) and the inner wall surface of the tubular member 2 are fixed to each other. Specifically, the stationary phase 3 shown in FIG. 1 has the skeletal structure 31 in the form of a three-dimensional network with the gaps 32 formed therein, which serve as passages for liquid (a liquid sample and an effluent liquid). A portion of the stationary phase 3 is fixed to the inner wall surface of the tubular member 2.

The stationary phase 3 can be fixed to the inner wall surface of the tubular member 2 without any filter. Thus, filters can be eliminated. As a result, the column 1 according to the present invention can avoid the problems caused by use of a filter, such as mixture of components due to a turbulent flow produced by gaps near a filter, clogging of a filter, and breakage of the tubular member 2 due to pressure increase of the interior of the tubular member 2.

Further, since the stationary phase 3 is fixed to the inner wall surface of the tubular member 2, gaps become unlikely to be formed between the stationary phase 3 and the inner wall surface of the tubular member 2. Accordingly, it is possible to reduce a variation of the flow velocity of a liquid flowing through the column 1.

As described above, for example, even if the diameter of a tubular member 2 is reduced, it is possible to obtain a column 1 that has a good separation performance and can perform an analysis with high accuracy and high sensitivity.

Further, as described above, the skeletal structure 31 of the stationary phase 3 is formed by a plurality of particles 33 integrally fixed to each other. Accordingly, the stationary phase 3 can have a large surface area. Specifically, the stationary phase 3 can have a large contact area with which components in a sample are brought into contact. Therefore, the stationary phase 3 can efficiently adsorb the components in the sample. In the present embodiment, the skeletal structure 31 of the stationary phase 3 is formed by a plurality of particles 33 connected (fixed) to each other. Such a skeletal structure 31 has a large contact area with which components in a sample are brought into contact. Accordingly, the skeletal structure 31 can efficiently hold the components in the sample.

It is desirable that the particles 33 have an average particle diameter of about 0.1 to 50 μm, and more preferably about 1 to 10 μm. In this case, it is possible to maintain a sufficient surface area of the stationary phase 3. Accordingly, it is possible to enhance a ratio at which the particles 33 in the stationary phase 3 hold components in the sample. If the particle diameter of the particles 33 is excessively small, then a liquid becomes unlikely to flow through gaps between the particles 33, thereby increasing a pressure in the column or requiring a long period of time for separation of components.

It is desirable that the stationary phase 3 has a specific surface area of about 10 to 1000 m²/g, and more preferably about 50 to 200 m²/g. In this case, the stationary phase 3 can maintain a sufficient efficiency of holding components of the sample and have such a mechanical strength so as not to be broken when a liquid passes through the stationary phase 3.

As described above, the entire tubular member 2 may be made of the same kind of material as the particles 33. Only its inner wall surface may be made of the same kind of material as the particles 33.

Further, as described above, the entire particle 33 may be made of the same kind of material as the tubular member 2. Only these surfaces may be made of the same kind of material as the tubular member 2.

Furthermore, when devices for fixing the particles 33 to the tubular member 2, such as filters, are provided on opposite ends of the tubular member 2, the stationary phase 3 may be formed by an aggregate of a plurality of particles 33 that are not fixed partly or entirely to each other. In this case, it is desirable that a portion of the particles 33 in the aggregate is fixed to the inner wall surface of the tubular member 2.

Next, there will be described a method of separating a liquid sample with use of the column 1 shown in FIG. 1. In this example, a calcium phosphate-based compound is used as a material of the stationary phase 3 and the tubular member 2.

First, a buffer solution is supplied to the column 1 so that the gaps 32 in the stationary phase 3 are filled with the buffer solution (priming step). Different kinds of buffer solutions are used depending upon a mixture sample to be separated. Examples of the buffer solution include various buffer solutions (liquids containing a buffer agent), such as triethanolamine hydrochloride-sodium hydroxide buffer solution, veronal (sodium 5,5-diethyl barbiturate)-hydrochloride buffer solution, tris-hydrochloride buffer solution, glycylglycine-sodium hydroxide buffer solution, 2-amino-2-methyl-1,3-propanediol-hydrochloride buffer solution, diethanolamine-hydrochloride buffer solution, boric acid buffer solution, sodium borate-hydrochloride buffer solution, glycine-sodium hydroxide buffer solution, sodium carbonate-sodium bicarbonate buffer solution, sodium borate-sodium hydroxide buffer solution, sodium bicarbonate-sodium hydroxide buffer solution, phosphate buffer solution, disodium phosphate-sodium hydroxide buffer solution, potassium chloride-sodium hydroxide buffer solution, Britton-Robinson buffer solution, and GTA buffer solution.

A liquid sample is prepared. The sample is not limited to a specific liquid. Examples of the sample include a liquid containing tissue-derived components such as peptide, protein (e.g., enzyme), and nucleic acid (e.g., DNA) and saccharide. More specifically, examples of the sample include blood and saliva. The prepared liquid sample is injected into the column 1.

The injected liquid sample flows through the gaps 32 in the stationary phase 3 from one end to another while it is brought into contact with the stationary phase 3. At least a portion of components in the liquid sample is adsorbed on the surface of the stationary phase 3 by an adsorbing force corresponding to their charge state. Components that have not been attached to the stationary phase 3 reach a lower end of the stationary phase 3 and are discharged from the discharge port. The injection of the liquid sample is stopped when a predetermined amount of liquid sample passes through the stationary phase 3. In this manner, predetermined components in the sample are adsorbed on the stationary phase 3. When the stationary phase 3 (the particles 33) is mainly made of a calcium phosphate-based compound as described above, tissue-derived components are efficiently adsorbed on the stationary phase 3.

It is desirable that a flow rate of the liquid sample is in a rage of about 0.01 to 10 μL/min, and more preferably about 0.1 to 5 μL/min. In this case, a long period of time is not required to flow the liquid sample through the stationary phase 3, so that it is possible to prevent tissue-derived components or the like from being altered and deteriorated during the flow of the liquid sample. At the same time, it is possible to maintain a sufficient efficiency of adsorbing components in the sample by the stationary phase 3 (column 1).

Next, an effluent liquid is supplied to the column 1 to elute the components adsorbed on the stationary phase 3. For example, a pH or a salt concentration of the same kind of buffer solution as described above may be adjusted and used as the effluent liquid. Alternatively, an additive may be added to the same kind of buffer solution as described above and used as the effluent liquid.

The supplied effluent liquid flows through the gaps 32 in the stationary phase 3 from one end to another while it is brought into contact with the stationary phase 3. When the effluent liquid is brought into contact with the stationary phase 3, the components attached to the stationary phase 3 are sequentially eluted into the effluent liquid depending upon differences of their adsorbing forces to the stationary phase 3 by, for example, a varied charge state on the surface of the stationary phase 3. Then, the eluted components are discharged from the discharge port.

Component measurement is consecutively performed on the discharged effluent liquid to analyze the sample. Alternatively, the effluent liquid is consecutively recovered by a plurality of fractions to separate and recover specific components contained in the sample.

It is desirable that a flow rate of the effluent liquid is in a rage of about 0.01 to 10 μL/min, and more preferably about 0.1 to 5 μL/min. In this case, a long period of time is not required to flow the effluent liquid through the stationary phase 3, so that it is possible to prevent tissue-derived components or the like from being altered and deteriorated during the flow of the effluent liquid. At the same time, it is possible to efficiently recover the components necessary and sufficient for analysis.

Next, a method of manufacturing a column according to the present invention will be described below in a case where the column shown in FIG. 1 is manufactured. In this example, a calcium phosphate-based compound is used as a material of the stationary phase 3 and the tubular member 2. Further, a wet synthesis method is used to synthesize the calcium phosphate-based compound. A wet synthesis method does not require expensive manufacturing facilities but can efficiently synthesize the calcium phosphate-based compound relatively easily.

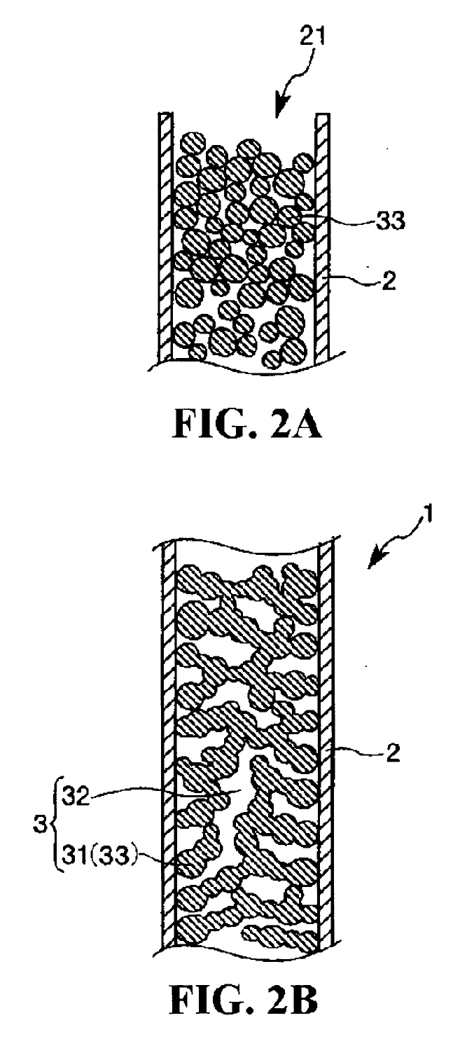

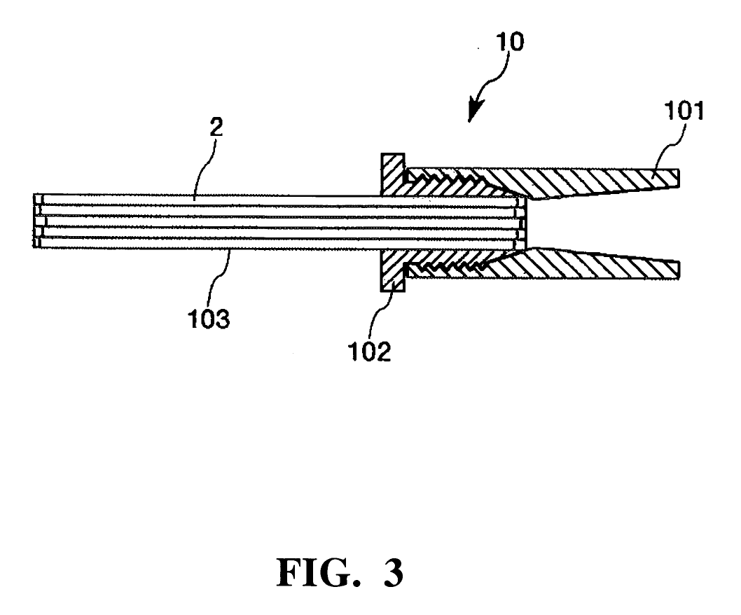

FIGS. 2A, 2B, and 3 are schematic views explanatory of a method of manufacturing the column shown in FIG. 1. In the following description, upper and lower sides in FIGS. 2A and 2B will be referred to as “upper” and “lower,” respectively.

1) Manufacturing Particles

First, a phosphoric acid solution or a phosphate solution is mixed with a calcium salt solution, for example, in a container (not shown) so as to produce slurry containing a calcium phosphate-based compound by the reaction of the solutions. Examples of the phosphate include ammonium phosphate, diammonium hydrogen phosphate, and sodium phosphate. Further, examples of the calcium salt include calcium hydroxide, calcium nitrate, and calcium chloride.

Then, the produced slurry is dried. Thus, particles 33 of a calcium phosphate-based compound are produced. A spray drying method using a spray dryer or the like is suitably used to dry the slurry. According to a spray drying method, it is possible to reliably produce particles 33 in a short period of time. It is desirable that a drying temperature is in a range of about 100 to 300° C., and more preferably about 150 to 250° C.

Next, the particles thus produced are classified to recover particles 33 having a desired particle diameter. It is desirable that the recovered particles have an average particle diameter of about 0.1 to 30 μm, and more preferably about 2 to 20 μm. The recovered particles 33 are shrunk during a heat treatment in steps 1) and 3). By recovering particles 33 having an average particle diameter in the above range, it is possible to obtain particles 33 having an adequate particle diameter after the heat treatment in step 3).

Then, a heat treatment (temporary burning) is performed on the recovered particles 33. The particles 33 are shrunk and densified. Examples of a method of performing a heat treatment on the particles 33 include heating in a furnace or the like, contact with plasma, application of a microwave, and application of laser beam.

Specific conditions of the heat treatment are determined depending upon composition, volume, and weight of the material of the particles 33. For example, the heat treatment temperature is preferably set at about 400 to 1250° C., and more preferably about 700 to 1200° C. In the above temperature range, the heat treatment can be performed without decomposing or sintering the calcium phosphate-based compound. Further, the above temperature range is lower than a temperature range in step 3), which will be described later. Accordingly, in step 1), it is possible to reliably prevent liquid-phase components in the particles 33 from suddenly volatilizing to cause cracks and voids in the particles 33.

Further, a period of time for the heat treatment is preferably in a range of about 0.5 to 10 hours, and more preferably about 1 to 5 hours. The heat treatment can be performed reliably in this range. Although the heat treatment may be performed for a period of time longer than the upper limit of the above range, further effects of the heat treatment are not expected.

Furthermore, a rate of temperature increase is preferably in a range of about 10 to 200° C./hour, and more preferably about 30 to 100° C./hour. In this range, it is possible to more reliably prevent liquid-phase components in the particles 33 from suddenly volatilizing to cause cracks and voids in the particles 33.

In a case where a synthetic product is a calcium phosphate-based compound such as hydroxyapatite, examples of an atmosphere of the heat treatment include the air, an oxygen gas atmosphere, a nitrogen gas atmosphere, an argon gas atmosphere, and a reduced-pressure atmosphere. In a case of other synthetic products, examples of an atmosphere of the heat treatment include a reduced-pressure atmosphere and an atmosphere including an inert gas such as an argon gas, a helium gas, and a nitrogen gas.

The heat treatment (temporary burning) can be performed depending upon a degree of sintering of the tubular member 2 to be subjected to step 3) (thermal hysteresis). Specifically, the heat treatment may be performed selectively so that the degree of sintering of the tubular member 2 is equal to or lower than a degree of sintering of the particles 33 at the time of step 3). For example, when the tubular member 2 to be subjected to step 3) is a green compact of slurry, the heat treatment can be dispensed with in step 1). If the temporary burning is not conducted, the thermal hysteresis of the particles 33 can substantially be the same as the thermal hysteresis of the tubular member 2. Accordingly, the particles 33 and the tubular member 2 are shrunk substantially at the same shrinkage percentage during a heat treatment (primary burning) in step 3). As a result, gaps are unlikely to be formed between the stationary phase 3 and the inner wall surface of the tubular member 2. Thus, it is possible to obtain a column 1 in which the stationary phase 3 is reliably fixed to the inner wall surface of the tubular member 2.

In this case, the particles 33 are sintered in the temporary burning to such a degree of incomplete sintering that further sintering can be conducted in the primary burning of step 3).

2) Manufacturing Tubular Member

First, slurry containing a calcium phosphate-based compound is produced in the same manner as step 1).

Then, the produced slurry is formed into a predetermined shape by various molding methods such as an injection molding method, an extrusion molding method, and a press molding method. Thus, a tubular member 2 is produced. The size of the tubular member 2 is determined in consideration of shrinkage in a heat treatment, which will be described later.

The produced tubular member 2 is dried by, for example, natural drying, warm-air drying, freeze-drying, vacuum drying, and the like.

Next, a heat treatment (temporary burning) is performed on the dried tubular member 2. It is desirable that the heat treatment is performed on the tubular member 2 under such conditions that a degree of sintering of the tubular member 2 after the heat treatment (thermal hysteresis) is lower than a degree of sintering of the particles 33 to be subjected to step 3) (thermal hysteresis).

It is desirable that the degree of sintering of the tubular member 2 in the temporary burning is equal to or lower than the degree of sintering of the particles 33 produced in step 1). It is more desirable that the degree of sintering of the tubular member 2 in the temporary burning is equal to the degree of sintering of the particles 33 produced in step 1). In this case, the particles 33 and the tubular member 2 are shrunk substantially at the same shrinkage percentage during a heat treatment (primary burning) in step 3). Alternatively, the tubular member 2 is shrunk at a shrinkage percentage higher than that of the particles 33 during a heat treatment (primary burning) in step 3). Accordingly, gaps are unlikely to be formed between the stationary phase 3 and the inner wall surface of the tubular member 2. Thus, it is possible to obtain a column 1 in which the stationary phase 3 is reliably fixed to the inner wall surface of the tubular member 2.

The above heat treatment can be performed under the same conditions as step 1) in the same manner as step 1). In this case, the tubular member 2 is sintered in the temporary burning to such a degree of incomplete sintering that further sintering can be conducted in the primary burning of step 3).

The heat treatment (temporary burning) can be performed depending upon a degree of sintering of the particles 33 to be subjected to step 3) (thermal hysteresis). For example, when the particles 33 to be subjected to step 3) are green compacts of slurry, the heat treatment can be dispensed with in step 2). In this case, it is possible to obtain a column 1 in which the stationary phase 3 is reliably fixed to the inner wall surface of the tubular member 2 as with step 1). Further, the heat treatment may be dispensed with, and a separately produced tubular member 2 may be used.

3) Manufacturing Column

First, as shown in FIG. 2A, the produced particles 33 are filled into the tubular member 2 (first process). For example, the particles 33 are filled into the tubular member 2 by the following method a) or b).

a) A particle containing liquid containing a plurality of particles 33 and a liquid component is supplied and filled into the tubular member 2 while the particles 33 are moved toward one end of the particles 33. Then, the liquid component is removed from the particle containing liquid.

b) A plurality of particles 33 are supplied to the tubular member 2. Then, the particles 33 are consolidated.

According to the method a), since the particle containing liquid containing the particles 33 is used, the particles 33 can readily be moved within the tubular member 2. Accordingly, it is possible to efficiently fill the particles 33 into the tubular member 2 with ease.

In order to move the particles 33 in the method a), for example, one end of the tubular member 2 supplied with the particle containing liquid containing the particles 33 may be directed vertically downward and left for a certain period of time to utilize natural sedimentation of the particles 33. Alternatively, a particle filling device 10 as shown in FIG. 3 may be used to fill the particles 33 into the tubular member 2.

The particle filling device 10 is attached to a rotation mechanism such as a centrifugal separator. The particle filling device 10 is rotated to apply centrifugal forces to the particles 33 so as to move the particles 33 toward one end of the tubular member 2. Thus, the particles 33 can be moved efficiently.

The particle filling device 10 has a cylindrical reservoir 101, a cylindrical fitting 102, and a cylindrical glass tube 103 having a bottom. The reservoir 101 has a first end attached to a rotational shaft of the rotation mechanism and a second end to which the fitting 102 is mounted by a screw. The glass tube 103 is fitted into a hollow portion of the fitting 102 in a state such that the bottom of the glass tube 103 is located outside of the rotation orbit of the rotation mechanism.

The glass tube 103 has a length larger than the tubular member 2, into which the particles 33 are to be filled. A plurality of tubular members 2 are housed within the glass tube 103 so that ends of the tubular members 2 are brought into contact with the bottom of the glass tube 103. A particle containing liquid containing particles 33 and a liquid component is supplied to the hollow portion of the reservoir 101.

The particle filling device 10 is rotated in such a state by a centrifugal separator or the like. The heat treatment particles supplied to the reservoir 101 are moved toward the outside of the rotation orbit by centrifugal forces and thus supplied into the tubular members 2. At that time, centrifugal forces toward the outside of the rotation orbit are continuously applied to the particles 33. Accordingly, the particles 33 are sequentially filled from ends of the tubular members 2. The particle filling device 10 is rotated until the entire tubular members 2 are filled with the particles 33.

With use of the particle filling device 10 and centrifugal forces, the particles 33 can be filled into the tubular member 2 at a high density. Further, it is possible to readily fill the particles 33 into a number of tubular members 2 by only one operation.

The liquid component in the particle containing liquid is removed by various drying methods such as natural drying, warm-air drying, freeze-drying, and vacuum drying.

The liquid component in the particle containing liquid is not limited to specific component. Examples of the liquid component include various kinds of water such as distilled water, ion exchanged water, and reverse osmosis water, alcohols such as methanol, ethanol, propanol, isopropanol, butanol, allyl alcohol, furfuryl alcohol, ethylene glycol monoacetate, ethylene glycol, glycerin, diethylene glycol, and triethanolamine, halogenated hydrocarbons such as methylene chloride, chloroform, 1,2-dichloroethane, and 1,1,2,2-tetrachloroethane, hydrocarbons such as n-hexane, petroleum ether, toluene, benzene, and xylene, ketones such as acetone, methyl ethyl ketone, and methyl isobutyl ketone, esters such as ethyl acetate and methyl acetate, ethers such as diethyl ether, diisopropyl ether, tetrahydrofuran, and dioxane, nitrites such as acetonitrile and propionitrile, dimethylformamide, dimethylacetamide, hexamethylphosphoric triamide, dimethyl sulfoxide, sulfolane, dimethoxyethane, N-methyl pyrrolidone, 1,3-dimethyl-2-imidazolidinone, grease, and silicone oil. Two or more components of the above examples may be combined with each other.

According to the method b), the particles 33 can readily be filled into the tubular member 2 without a device such as a rotation mechanism.

For example, in the method b), particles 33 may be compressed toward one end of the tubular member 2 by a jig so as to consolidate the particles 33. Alternatively, one end of the tubular member 2 to which the particles 33 have been supplied may be directed vertically downward, and vibration may be applied to the tubular member 2 to consolidate the particles 33. For example, the vibration may be applied by tapping, ultrasonic application, or the like. When the particles 33 are consolidated by the application of the vibration, it is possible to reliably prevent deformation of the particles 33 and the tubular member 2 and efficiently fill the particles 33 into the tubular member 2.

Then, a heat treatment (primary burning) is performed on the tubular member 2 filled with the particles 33 (second process). This heat treatment causes bonding between the particles 33 and between a portion of the stationary phase 3 and the inner wall surface of the tubular member 2 due to interdiffusion. Thus, the particles 33 are connected to each other so as to form a skeletal structure 31. The skeletal structure 31 and the inner wall surface of the tubular member 2 are fixed to each other. As a result, as shown in FIG. 2B, it is possible to produce a column 1 including the stationary phase 3 having the skeletal structure 31 with gaps 32 formed therein and the tubular member 2 fixed to a portion of the stationary phase 3.

At that time, as described above, if a degree of sintering of the tubular member 2 (thermal hysteresis) is equal to or lower than a degree of sintering of the particles 33 (thermal hysteresis), then the particles 33 and the inner wall surface of the tubular member 2 are shrunk while they are brought into contact with each other. It is possible to produce a column 1 in which the particles 33 and the inner wall surface of the tubular member 2 are reliably fixed to each other.

It is desirable that the temperature is gradually increased to a burning temperature during the heat treatment. Specifically, for example, the temperature is increased to a first temperature at a first rate of temperature increase and then increased to a second temperature (burning temperature) at a second rate of temperature increase. Thereafter, the temperature is gradually lowered after it is held at the second temperature for a predetermined period of time. When the temperature is gradually increased, it is possible to fix the particles 33 to each other and fix the stationary phase 3 to the inner wall surface of the tubular member 2 while shapes of the particles 33 and the tubular member 2 are maintained.

The first rate of temperature increase is preferably in a range of about 60 to 900° C./hour, and more preferably about 300 to 600° C./hour. In this range, it is possible to efficiently increase the temperature while liquid-phase components remaining in the particles 33 or in the tubular member 2 are prevented from suddenly volatilizing.

The first temperature is preferably in a range of about 300 to 1200° C., and more preferably about 300 to 1000° C. In this range, the particles 33 and the entire tubular member 2 can have a substantially uniform temperature so that sintering at the second temperature can uniformly be conducted. As a result, it is possible to prevent biased sintering and deformation of the particles 33 and the tubular member 2 after the sintering.

The second rate of temperature increase is set to be lower than the first rate of temperature increase and thus varied according to the first rate of temperature increase. The second rate of temperature increase is preferably in a range of about 30 to 200° C./hour, and more preferably about 50 to 150° C./hour. In this range, the particles 33 and the tubular member 2 can be uniformly sintered by the heat treatment at the second temperature.

The second temperature is set to be higher than the first temperature and thus varied according to the first temperature. The second temperature is preferably in a range of about 1200 to 1450° C., and more preferably about 1200 to 1400° C. In this range, the particles 33 and the tubular member 2 can reliably be sintered by the heat treatment while the calcium phosphate-based compound (ceramic material) is prevented from being decomposed. Further, it is possible to reliably fix the particles 33 to each other and reliably fix the stationary phase 3 to the inner wall surface of the tubular member 2.

The period of time during which the second temperature is held is slightly different depending upon the second temperature and is preferably in a range of about 0.5 to 10 hours, and more preferably about 1 to 5 hours. In this range, shape deformation of the particles 33 and the tubular member 2 during the sintering can be optimized. The bonding. can reliably be conducted while the shapes of the particles 33 and the tubular member 2 are maintained.

It is to be noted that the heat treatment in steps 2) and 3) can be performed into the same atmosphere as that which has been described in step 1).

Further, the heat treatment in steps 2) and 3) can be performed by the same manner as that which has been described in step 1).

When a heat treatment is performed under the above conditions, it is possible to produce a column 1 by fixing the particles 33 to each other and fixing a portion of the stationary phase 3 to the inner wall surface of the tubular member 2 while reliably maintaining the shape of the particles 33.

Although certain preferred embodiments of the present invention have been shown and described in detail, the present invention is not limited to the illustrated embodiments. For example, components of a column according to the present invention may be replaced with any component having the same function. Further, for example, one or more processes may be added to the aforementioned processes as needed.

### EXAMPLES

Next, specific examples of the present invention will be described below.

1. Manufacturing Column

### Example I

1) First, a phosphoric acid solution and a calcium hydroxide solution were mixed with each other so as to produce slurry containing hydroxyapatite.

2) Then, the slurry containing hydroxyapatite was dried at 200° C. by a spray dryer so as to produce hydroxyapatite particles (HA particles). Subsequently, the HA particles were classified.

3) Next, the HA particles were transferred to an electric furnace, where the HA particles were increased in temperature to 400° C. at a rate of temperature increase of 50° C./hour and held at 400° C. for 4 hours.

4) Then, the slurry containing hydroxyapatite was molded into a cylindrical shape by an injection molding apparatus so as to produce a capillary (tubular member). Subsequently, the capillary was dried at a room temperature.

5) Next, the capillary was transferred to the electric furnace, where the capillary was increased in temperature to 1050° C. at a rate of temperature increase of 50° C./hour and held at 1050° C. for 4 hours. Thus, a capillary having an outside diameter of 300 μm and an inside diameter of 70 μm was obtained.

6) Then, the HA particles produced in step 3) were transferred to the electric furnace, where the HA particles were increased in temperature to 1050° C. at a rate of temperature increase of 50° C./hour and held at 400° C. for 4 hours so as to conduct temporary burning on the HA particles. Thus, HA particles having an average particle diameter of 10 μm were obtained. The obtained HA particles were introduced into isopropanol to prepare a particle containing liquid containing HA particles. The particle containing liquid containing HA particles was supplied to a reservoir of a particle filling device as shown in FIG. 3. Further, the capillary produced in step 5) was inserted into a glass tube of the particle filling device. Then, the particle filling device was rotated at 500 rpm for 10 minutes by a centrifugal separator so as to fill the HA particles into the capillary.

7) Next, the capillary filled with the HA particles was increased in temperature to 1000° C. at a rate of temperature increase of 600° C./hour, then increased in temperature to 1400° C. at a rate of temperature increase of 100° C./hour, and held at 1400° C. for 4 hours. Thus, the HA particles were fixed to each other so as to form a stationary phase. The stationary phase was fixed to an inner wall surface of the capillary.

According to the above steps, a column was produced.

### Example II

A column was produced in the same manner as Example I except that materials used in steps 1) and 4) of Example I were changed from hydroxyapatite to tricalcium phosphate.

### Example III

A column was produced in the same manner as Example I except that materials used in steps 1) and 4) of Example I were changed from hydroxyapatite to alumina.

### Example IV

1) First, a phosphoric acid solution and a calcium hydroxide solution were mixed with each other so as to produce slurry containing hydroxyapatite.

2) Then, the slurry containing hydroxyapatite was dried at 200° C. by a spray dryer so as to produce hydroxyapatite particles (HA particles). Subsequently, the HA particles were classified.

3) Next, the HA particles were transferred to an electric furnace, where the HA particles were increased in temperature to 400° C. at a rate of temperature increase of 50° C./hour and held at 400° C. for 4 hours.

4) Then, the slurry containing hydroxyapatite was molded into a cylindrical shape by an injection molding apparatus so as to produce a capillary (tubular member). Subsequently, the capillary was dried at a room temperature.

5) Next, the capillary was transferred to the electric furnace, where the capillary was increased in temperature to 1050° C. at a rate of temperature increase of 50° C./hour and held at 1050° C. for 4 hours. Thus, a capillary having an outside diameter of 1.7 mm and an inside diameter of 185 μm was obtained.

6) Then, the HA particles produced in step 3) were transferred to the electric furnace, where the HA particles were increased in temperature to 1050° C. at a rate of temperature increase of 50° C./hour and held at 400° C. for 4 hours so as to conduct temporary burning on the HA particles. Thus, HA particles having an average particle diameter of 10 μm were obtained.

7) A funnel was inserted into one end of the capillary produced in step 5). The HA particles produced in step 6) were introduced into the capillary via the funnel. Then, the HA particles were sequentially filled into the other end of the capillary and consolidated by a tapping method.

8) Next, the capillary filled with the HA particles was increased in temperature to 1000° C. at a rate of temperature increase of 600° C./hour, then increased in temperature to 1400° C. at a rate of temperature increase of 100° C./hour, and held at 1400° C. for 4 hours. Thus, the HA particles were fixed to each other so as to form a stationary phase. The stationary phase was fixed to an inner wall surface of the capillary.

According to the above steps, a column was produced.

### Example V

A column was produced in the same manner as Example IV except that the temporary burning temperature of the capillary in step 5) of Example IV was changed to 950° C. In this case, a degree of sintering of the capillary after the temporary burning was lower than a degree of sintering of the HA particles produced in step 6) of Example IV.

### Reference Example VI

A column was produced by packing sintered HA particles into a capillary made of stainless steel having an outside diameter of 300 μm and an inside diameter of 70 μm at the same filling factor as Example I.

### Reference Example VII

A column was produced by packing sintered HA particles into a capillary made of stainless steel having an outside diameter of 1.7 mm and an inside diameter of 185 μm at the same filling factor as Example IV.

2. Evaluation

2.1 Observation and evaluation of internal structure of column

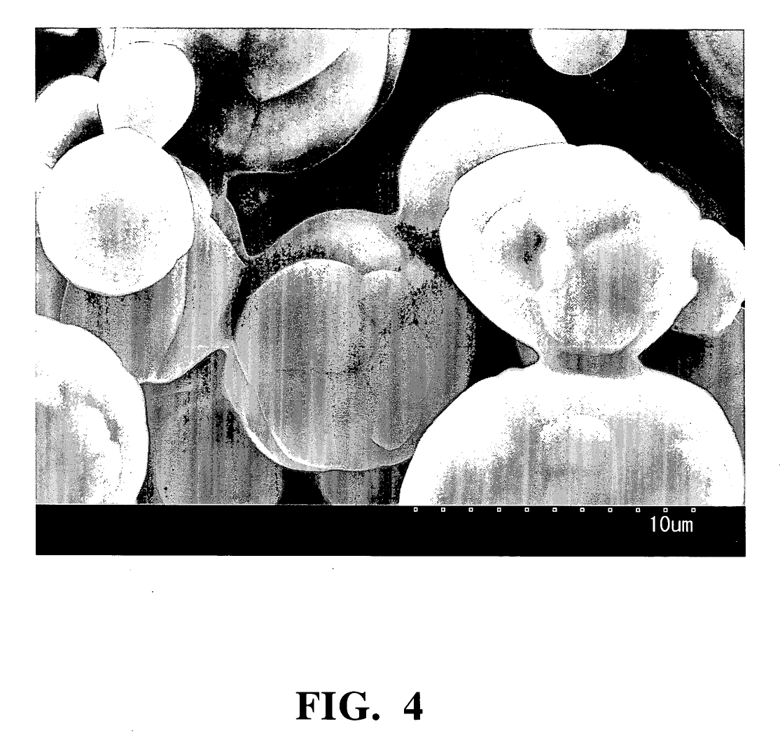

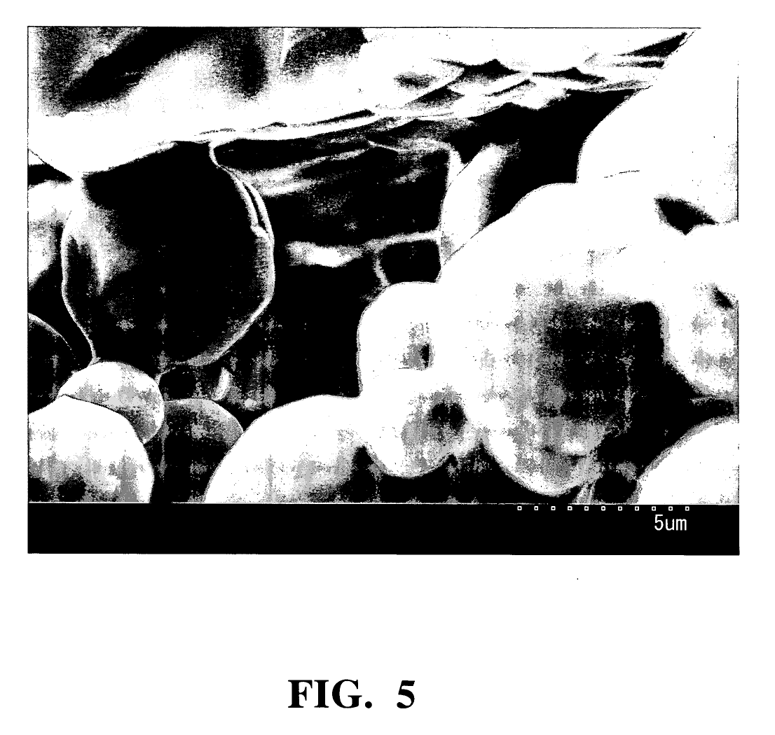

Cross sections of the columns produced in Examples I to V and Reference Examples VI and VII were observed near an interface between an inner wall surfaces of the capillary and the stationary phase by using a scanning electron microscope, S-4300 manufactured by Hitachi, Ltd. Photomicrographs of the column produced in Example I are representatively shown in FIGS. 4 and 5.

As is apparent from FIG. 4, HA particles were fixed to each other in the column produced in Example I. FIG. 5 shows that a crosslinked structure was formed between the inner wall surface of the capillary and the stationary phase. As with the HA particles, the stationary phase was fixed to the inner wall surface of the capillary.

Further, in the columns produced in Examples II to V, HA particles were fixed to each other while the stationary phase was fixed to an inner wall surface of the capillary, as with Example I.

Each photomicrograph of the column produced in Reference Examples VI and VII shows that many gaps were formed in a state such that HA particles were not fixed to each other and that the stationary phase was not fixed to an inner wall surface of the capillary.

Particularly, in Example I, a degree of bonding between an inner wall surface of the capillary and the stationary phase was extremely high. This is probably because particles were efficiently moved and filled at a high density by supplying the particle containing liquid containing the particles and applying centrifugal forces to the particles.

Further, a composition analysis of a portion of the capillary and a portion of the stationary phase in a transverse cross section was performed on the columns produced in Examples I, IV and V by using an energy-dispersive X-ray analyzer (EDX), EMAXENERGY manufactured by Horiba, Ltd. As a result, those portions were formed by Ca, P, and O.

Specifically, in Examples I, IV and V, the portion of the capillary had a Ca/P ratio of 1.6 while the portion of the particles had a Ca/P ratio of 1.7. Those portions were formed by hydroxyapatite.

2.2 Evaluation of separation performance of components Next, an analysis of a liquid sample was performed with use of the columns produced in Examples I to V and Reference Examples VI and VII.

First, a phosphate buffer solution of 1 mM (pH 6.8) was supplied into the column so as to fill the column with the phosphate buffer solution. Then, BSA, lysozyme, and cytochrome-c were prepared as a liquid sample. The liquid sample was supplied into the column so as to adsorb components in the liquid sample on the stationary phase of the column.

Next, a phosphate buffer solution of 200 mM (pH 6.8) was supplied into the column so as to elute the components adsorbed on the stationary phase. Component measurement was consecutively performed at 280 nm on an effluent liquid discharged from the column by a UV detector.

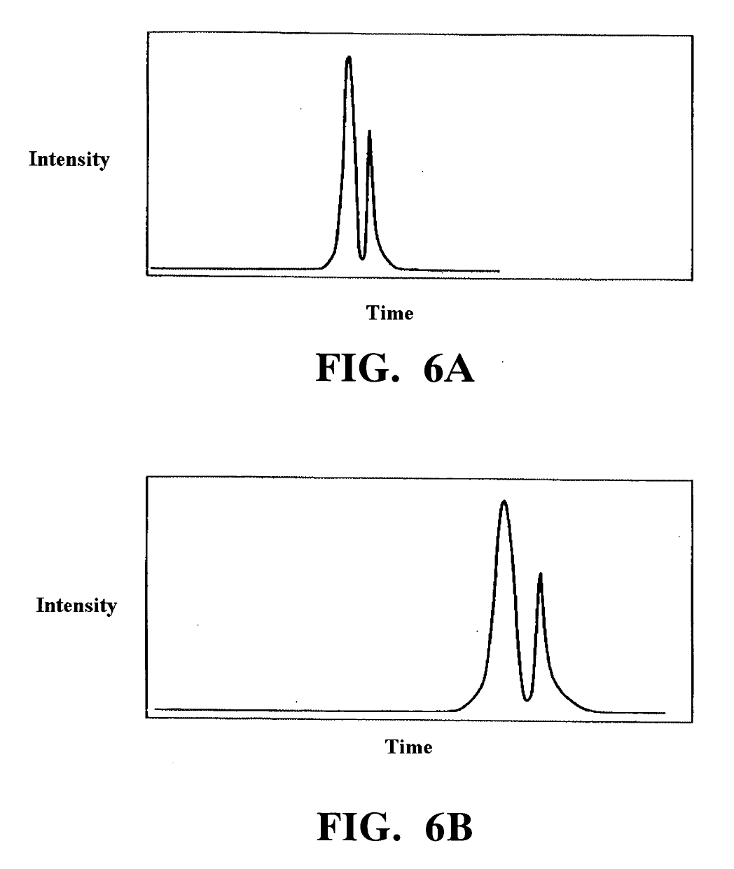

FIG. 6A representatively shows measurement results of the column produced in Example I, and FIG. 6B representatively shows measurement results of the column produced in Reference Example VI.

As shown in FIGS. 6A and 6B, a spectrum of the column produced in Example I had a period of time required for detecting components (retention time) that was shorter than that of a spectrum of the column produced in Reference Example VI. Further, Examples II to V, which are not shown, also had similar results to the results of Example I.

Further, two peaks of each spectrum of the columns produced in Examples I to V were separated from each other to the same degree as the spectrum of Reference Examples, which had a longer retention time.

Thus, it was proved that the columns produced in Examples I to V could analyze components for a shorter period of time.

Although certain preferred embodiments of the present invention have been shown and described in detail, it should be understood that various changes and modifications may be made therein without departing from the scope of the appended claims.

Finally, it is also to be understood that the present disclosure relates to subject matter contained in Japanese Patent Application No. 2005-335938 and No. 2005-335939 (both filed on Nov. 21, 2005) which are expressly incorporated herein by reference in its entirety.

What is claimed is:

1. A column for adsorbing a component in a sample, the column comprising:
a tubular member through which a sample flows; and
a stationary phase housed in the tubular member and formed by an aggregate of a plurality of particles, at least a portion of surfaces of the particles being made of a same material as at least a portion of an inner wall surface of the tubular member so that a component in the sample is adsorbed on both of the surfaces of the particles and the inner wall surface of the tubular member.

2. The column as claimed in claim 1, wherein a portion of the stationary phase is fixed to the inner wall surface of the tubular member.

3. The column as claimed in claim 1, wherein the plurality of particles are fixed to each other so as to integrally form the aggregate.

4. The column as claimed in claim 1, wherein the plurality of particles have an average particle diameter of 0.1 to 50 μm.

5. The column as claimed in claim 1, wherein the stationary phase has a specific surface area of 10 to 1000 m²/g.

6. The column as claimed in claim 1, wherein the tubular member includes an inner hollow portion having a cross-sectional area of 0.001 to 1.0 mm² in a direction perpendicular to a direction in which the sample flows through the tubular member.

7. The column as claimed in claim 1, wherein an entirety of the tubular member is made of a same material as the at least a portion of surfaces of the particles.

8. The column as claimed in claim 1, wherein an entirety of the at least a portion of surfaces of the particles is made of a same material as the at least a portion of an inner wall surface of the tubular member.

9. The column as claimed in claim 1, wherein the same material comprises a ceramic material.

10. The column as claimed in claim 9, wherein the ceramic material includes a calcium phosphate-based compound as a primary component.

11. The column as claimed in claim 10, wherein the calcium phosphate-based compound includes hydroxyapatite or tricalcium phosphate as a primary component.

12. A method of manufacturing a column, the method comprising:
filling a plurality of particles for a stationary phase into a tubular member; and
performing a heat treatment on the tubular member filled with the plurality of particles to fix the plurality of particles to each other for forming the stationary phase and to fix a portion of the stationary phase to an inner wall surface of the tubular member.

13. The method as claimed in claim 12, wherein the tubular member and the plurality of particles used in the filling process comprise a compact of a ceramic material or a temporary sintered member in which temporary burning is conducted on a compact of a ceramic material.

14. The method as claimed in claim 13, wherein the temporary sintered member forming the tubular member and the temporary sintered member forming the plurality of particles have substantially a same degree of sintering.

15. The method as claimed in claim 13, wherein the tubular member and the plurality of particles are made of a same ceramic material.

16. The method as claimed in claim 15, wherein the same ceramic material includes a calcium phosphate-based compound as a primary component.

17. The method as claimed in claim 16, wherein the calcium phosphate-based compound includes hydroxyapatite or tricalcium phosphate as a primary component.

18. The method as claimed in claim 12, wherein the filling process comprises:
supplying a particle containing liquid containing the plurality of particles and a liquid component into the tubular member;
moving the plurality of particles toward an end of the tubular member; and
removing the liquid component from the particle containing liquid.

19. The method as claimed in claim 18, wherein the moving process comprises applying a centrifugal force toward the end of the tubular member to the plurality of particles.

20. The method as claimed in claim 12, wherein the filling process comprises:
supplying the plurality of particles into the tubular member; and
consolidating the plurality of particles.

21. The method as claimed in claim 20, wherein the consolidating process comprises applying vibration to the tubular member supplied with the plurality of particles.

22. The method as claimed in claim 12, wherein the heat treatment is performed at a heat treatment temperature of 1200 to 1450° C.

23. The method as claimed in claim 22, wherein temperature is gradually increased to the heat treatment temperature.

24. The method as claimed in claim 12, wherein the heat treatment is performed for 0.5 to 10 hours.

25. The method as claimed in claim 12, wherein the tubular member includes an inner hollow portion having a cross-sectional area of 0.001 to 1.0 mm².
